(19) United States
(12) Patent Application Publication
(10) Pub. No.: US 2002/0065846 A1
(43) Pub. Date: May 30, 2002

(54) Spreadsheet Web server system and spreadsheet Web system

(76) Inventors: Atsuro Ogawa, Nagoya-shi (JP); Hideo Takata, Nagoya-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/994,941

(22) Filed: Nov. 28, 2001

(30) Foreign Application Priority Data
Nov. 30, 2000 (JP) 2000-364779
May 30, 2001 (JP) 2001-162801
Sep. 21, 2001 (JP) 2001-289181

(51) Int. Cl. G06F 15/00

(52) U.S. Cl. 707/503

(57) ABSTRACT

A client means and a Web server means perform data communication with each other over the Internet according to HTTP. A spreadsheet program, which is a program for displaying cell data in a table frame in which cells are arranged in at least one of the row direction and the column direction, has a function of generating a table frame and cell data as an HTML file. In response to a request from a browser, a spreadsheet assisting means causes the spreadsheet program to generate a table frame and cell data as an HTML file. A database means stores and manages, as records, cell data groups to be displayed in table frames.

### BACKGROUND OF THE INVENTION

1. Field of the Invention

The present invention relates to a spreadsheet Web server system and a spreadsheet Web system that generates, modifies, or deletes a table frame or cell data of a spreadsheet program in response to a request that is sent from a client means over the Internet or an intranet according to HTTP (hyper text transfer protocol).

2. Description of the Related Art

With the advancement of the Internet and intranet technologies and the increase of businesses using the Internet or an intranet, many Web systems have been developed that range from small-scale systems involving a small number of clients to large-scale systems in which an unspecified number of clients make access in real time.

Web systems are increasingly employing a layered structure as exemplified by what is called a three-layer Web system consisting of a client, an application server, and a database server.

However, as Web systems increasingly employ a layered structure, the systems become more complex. To construct and operate a Web system, it is necessary to understand a plurality of languages such as CGI (common gateway interface), HTML (hyper text markup language), XHTML (extensible hyper text markup language), and Java script (“Java” is a registered trademark of Sun Microsystems, Inc.). Further, to satisfy requirements of clients, Web systems need to be modified frequently. Therefore, construction and operation of a Web system are complex and require a number of steps.

Where various spreadsheet programs that are spread widely in the world are used in a stand-alone state or in a LAN (local area network), a table frame or cell data can be generated, modified, and deleted directly. However, a client accesses a spreadsheet file over the Internet or an intranet according to HTTP, the client can display a table frame and cell data but cannot generate, modify, or delete a table frame or cell data.

Although it is possible to download a file of a spreadsheet program from a server to a client using FTP (file transfer protocol) and upload a file in which a table frame or cell data have been generated, modified, or deleted to the server, this needs to follow a complex procedure.

### SUMMARY OF THE INVENTION

An object of the present invention is to provide a spreadsheet Web server system and a spreadsheet Web system capable of generating, modifying, or deleting a table frame or cell data in response to a request that is sent from a client means to a Web server over the Internet or an intranet according to HTTP.

Another object of the invention is to provide a spreadsheet Web server system and a spreadsheet Web system that facilitate development and maintenance of a spreadsheet assisting means for processing a request that is sent from a client to a Web server over the Internet or an intranet according to HTTP.

In a spreadsheet Web server system or a spreadsheet Web system according to a first aspect of the invention, client means and Web server means perform data communication with each other over the Internet or an intranet according to HTTP. Spreadsheet assisting means is provided that causes spreadsheet means to generate a hyperlink document file of a table frame and cell data read from database means according to a request from the client means, and causes the database means to generate, modify, or delete a record according to a request from the client means for generation, modification, or deletion of cell data. The term “table frame” means a set of cells having no cell data.

Since a spreadsheet program held by the spreadsheet means enables easy generation, modification, and deletion of various table frames, the number of steps of development and operation of a spreadsheet Web system can be decreased.

The spreadsheet assisting means inserts, into a hyperlink document file that has been generated by the spreadsheet means and consists of a table frame and cell data, a primary key value of a table of the database means corresponding to the table frame. For example, when a data modification request comes from the client means, modification data overwrites a record designated by a primary key value. Therefore, even if modification requests are made repeatedly in the same picture of the client means, no new record is generated in a table of the database means corresponding to a table frame . The term “primary key” means a table attribute that uniquely determines a record of each table that is held by a database.

When receiving a request for generation, modification, or deletion of cell data from the client means, the spreadsheet assisting means may judge whether a primary key value that was inserted into or attached to a hypertext document file by the spreadsheet assisting means coincides with a primary key value that is added to the request from the client means. This makes it possible to prevent illegal generation, modification, or deletion of data.

For example, the spreadsheet assisting means may hold a primary key value that is inserted into or attached to a hypertext document file by the spreadsheet assisting means and judge whether the primary key value being held by itself coincides with a primary key value that is added to a request from the client means.

Alternatively, the spreadsheet assisting means may insert a primary key value into not only a hypertext document file to be sent to the client means but also a non-rewritable data file that is to be sent to the client means being attached to the hypertext document file and is to be returned from the client means together with request data when a request comes from the client means. The spreadsheet assisting means judges whether a primary key value in request data coincides with a primary key value in a returned data file.

Each of the cell data groups that are managed by the database means as tables may have, in at least one cell of the corresponding table frame, only parent data that is cell data to be displayed in the cell , or the parent data and at least one child data that is linked to the parent data. The database means's having third-dimension cell data groups in addition to two-dimensional cell data groups to be displayed in cells of a table frame increases the degree of freedom in designing a table frame and a database. The child data may be an array or a table.

The spreadsheet Web server system may be configured in such a manner that the spreadsheet assisting means causes, according to a request from the client means, the spreadsheet means to generate, as a hyperlink document file, a table frame in which to display a child data group of a cell concerned of a table frame being displayed in the client means and the child data group, and the Web server means sends the generated hyperlink document file to the client means (the child data group can be displayed in the table frame being displayed in the client means), and that the spreadsheet assisting means causes the database means to generate, modify, or delete a record according to a request from the client means for generation, modification, or deletion of child data.

The database means may be able to combine a plurality of tables having the same column item at different column positions. This increases the degree of freedom in designing a table frame or a database.

The spreadsheet assisting means may have a sequence of commands for processing a request from the client means , the commands being executed sequentially. Alternatively, the spreadsheet assisting means may have objects for processing a request from the client means, and a request from the client means may be processed by one object or processed by a plurality of objects in such a manner that a transition is made from one object to another. At least one of the objects may have at least one action that is a sequence of commands for processing a request from the client means, the commands being executed sequentially, and an object or an action may be called by the client means or another action.

In each of the above cases, the spreadsheet assisting means processes a request from the client means by sequentially executing commands of each action, which makes it unnecessary to generate a complex program having branches and loops. Each command sequence can be formed by simple commands such as a command for instructing the database means to select, generate, modify, or delete a record, a command for stopping processing or switching to error processing based on a judgment, and a command for picture switching. Therefore, the configuration of the spreadsheet assisting means can be simplified and can be developed and maintained easily.

In a spreadsheet Web server system according to a second aspect of the invention, spreadsheet assisting means causes spreadsheet means to generate, modify, or delete a table frame or cell data according to a request from client means. With this configuration, a table frame or cell data can be generated, modified, or deleted directly by a client over the Internet or an intranet according to HTTP.

### BRIEF DESCRIPTION OF THE DRAWINGS

FIG. 1 is a block diagram of a spreadsheet Web system according to a first embodiment of the invention;

FIG. 2 shows action data that is sent from a CGI program to a spreadsheet assisting program;

FIG. 3 shows an HTML file that is sent from a Web server to a browser;

FIG. 4 shows a menu picture on the browser;

FIG. 5 shows a data input picture on the browser;

FIG. 6 shows a data modification or deletion picture on the browser;

FIG. 7 shows a browser picture according to a second embodiment of the invention;

FIG. 8 is a table showing a sequence of commands in a spreadsheet assisting means for processing each action corresponding to a request from a client means;

FIG. 9 illustrates an operation of combining two tables having the same column items into a single table;

FIG. 10 shows a flow of a process that is executed for a request from a client means in a spreadsheet Web system according to a third embodiment of the invention;

FIG. 11 shows the structure of an object according to the third embodiment;

FIG. 12 shows a flow of a process that is executed for a request from the client means in a spreadsheet Web system according to a fourth embodiment of the invention;

FIG. 13 shows the structure of three-dimensional cell data according to a fifth embodiment of the invention;

FIGS. 14A and 14B show browser pictures for displaying child data of a certain cell;

FIG. 15 is a block diagram of a spreadsheet Web system according to a sixth embodiment of the invention; and

FIG. 16 is a browser picture according to the sixth embodiment.

### DESCRIPTION OF THE PREFERRED EMBODIMENTS

Embodiments of the present invention will be hereinafter described with reference to the accompanying drawings.

### Embodiment 1

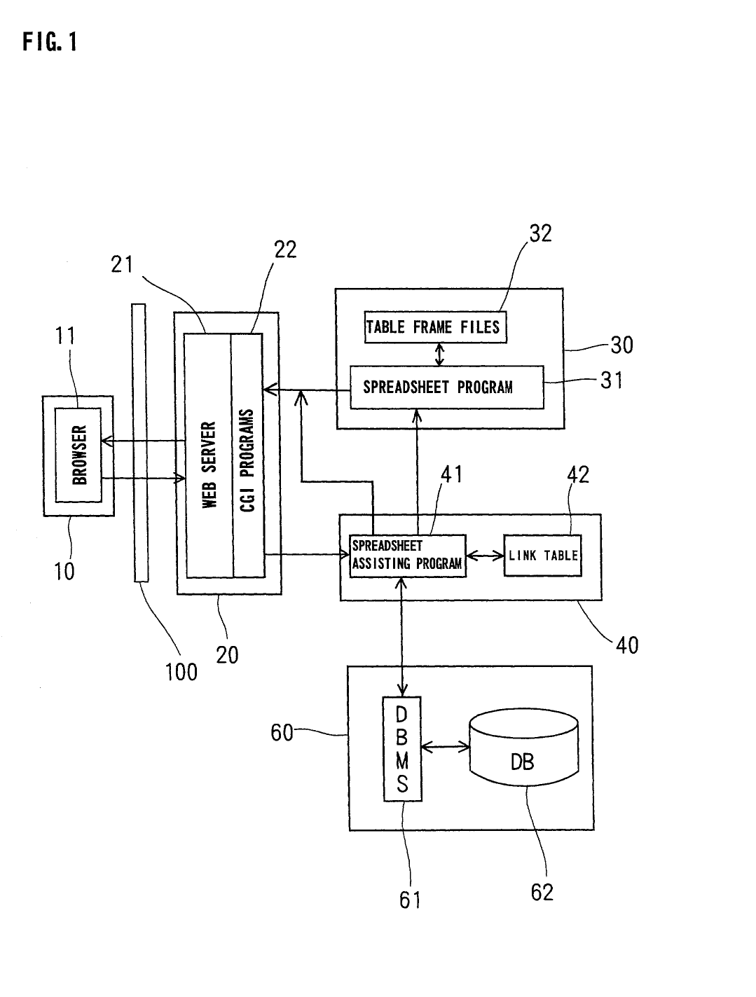

FIG. 1 is a block diagram showing a spreadsheet Web system according to a first embodiment of the invention. The spreadsheet Web system shown in FIG. 1 is a system that intensively manages expenditures of each section of a company on the Web. The spreadsheet Web system has a client means 10, a Web server means 20, a spreadsheet means 30, a spreadsheet assisting means 40, and a database means 60. In the spreadsheet Web system of FIG. 1, the means excluding the client means 10, that is, the Web server means 20, the spreadsheet means 30, the spreadsheet assisting means 40, and the database means 60, constitute a spreadsheet Web server system.

The client means 10 is a client computer that is installed in each section of the company. A browser 11 operates on the client computer that is connected to the Internet 100. An intranet may be used instead of the Internet 100. A Web server means 20 is a server computer, and a Web server 21 operates on a server computer. The client means 10 and the Web server means 20 perform data communication over the Internet 100 according to HTTP. A CGI program 22, which is a program written in CGI form, sends as an action a request from the client means 10 to a spreadsheet assisting program 41. A CGI program 22 suitable for a request from the client means 10 is started upon selection of a URL (uniform resource locator) on a browser picture of the client means 10.

The spreadsheet means 30 is a server computer or another computer that is connected to the server computer via a LAN (local area network). A spreadsheet program 31 operates in the spreadsheet means 30. The spreadsheet program 31 is a known type of program that displays cell data in a table frame in which cells are arranged at least in one of the row direction and the column direction. The spreadsheet program 31 can generate, modify, and delete a table frame. Further, the spreadsheet program 31 has a function of adding up cell data in the row direction and the column direction as well as a function of generating a table frame and cell data as an HTML document which is a hyperlink document. A hyperlink document may be generated by using a language other than HTML, such as XHTML. In the spreadsheet means 30, various table frame files 32 are recorded in a table frame recording means such as a hard disk drive.

The spreadsheet assisting means 40 is a server computer or another computer that is connected to the server computer via a LAN. A spreadsheet assisting program 41 operates in the spreadsheet assisting means 40. In the spreadsheet assisting means 40, a link table 42 containing link information that indicates correspondence between the table frame files 32 and tables in a DB (database) 62 is recorded in a link information recording means such as a hard disk drive.

In the database means 60, a DBMS (database management system) 61 manages the DB 62. Cell data groups to be displayed in table frames are recorded as tables in the DB 62.

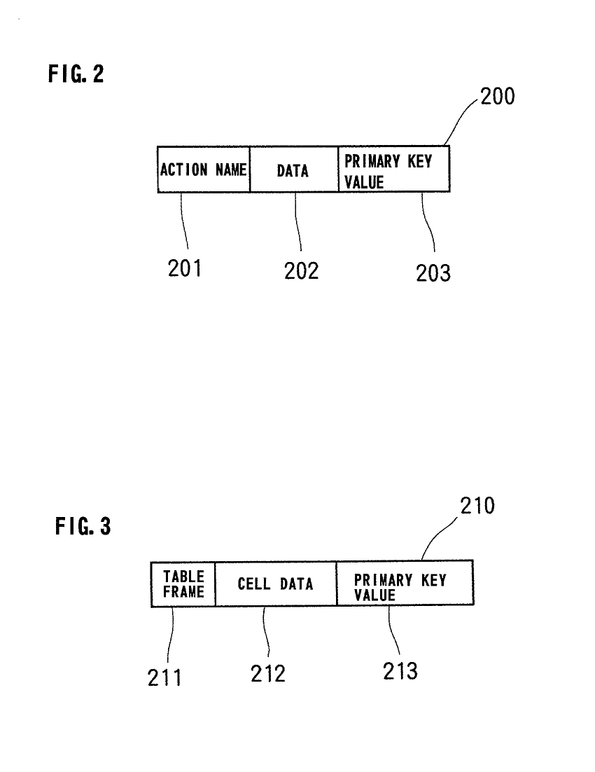

FIG. 2 shows exemplary action data indicating an action that is sent from a CGI program 22 to the spreadsheet assisting program 41. Although the structure of action data 200 varies depending on the request from the client means 10, an action name 201 is indispensable. The action name 201 shows a category of a manipulation to be performed by the spreadsheet assisting program 41 and a table frame number corresponding to the manipulation. That is, the action name 201 shows an operation category such as a cell data generation, modification, or deletion, or business form output as well as the number of a table frame to be generated by the spreadsheet program 31 as an HTML file.

Data 202 is data that was input through the browser 11 when cell data generation or modification was requested.

A primary key value 203 determines a table record in the DB 62 corresponding to the table frame with which cell data should be generated, modified, or deleted.

FIG. 3 shows an exemplary HTML file that is sent from the Web server 21 to the browser 11 based on an HTML file generated by the spreadsheet program 31. Although in FIG. 3 a table frame 211, cell data 212, and a primary key value 213 are drawn as separate items, actually they constitute a single HTML file 210. The primary key value 213 is the primary key value of a table in the DB 62 corresponding to the table frame 211.

Next, the operation of the spreadsheet Web system shown in FIG. 1 will be described.

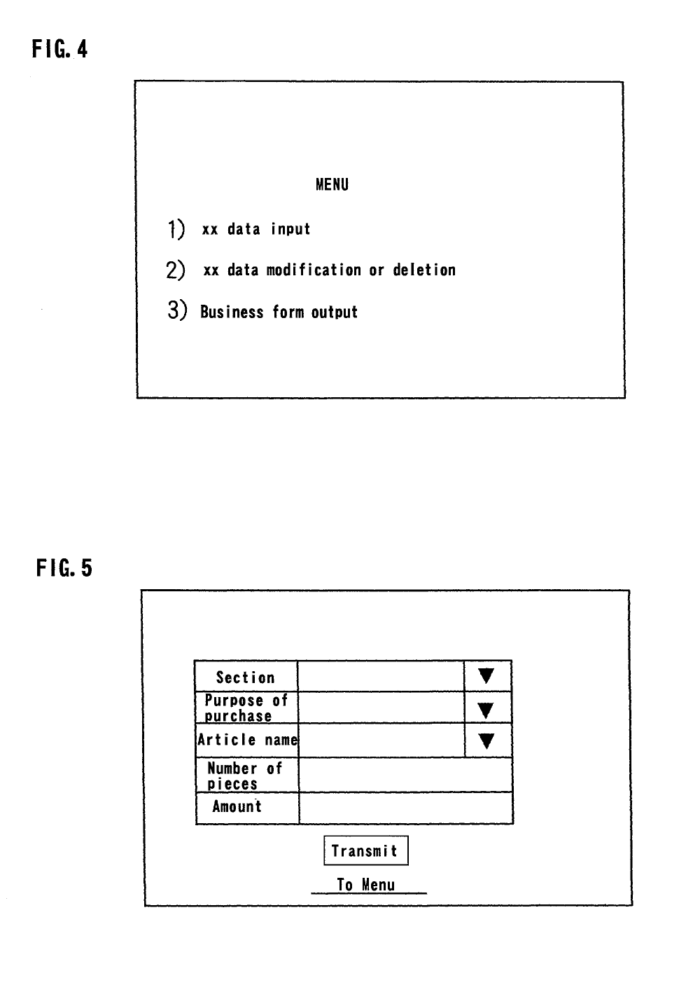

(1) When the browser 11 is started in the client means 10 and a connection is made to an expenditures management site of the Web server means 20, a menu picture shown in FIG. 4 is displayed. A browser tool bar is not shown in browser pictures shown in FIGS. 4-6.

(2) If “Data input” is selected in the picture of FIG. 4, a URL for selecting a corresponding CGI program 22 is sent to the Web server 21. The selection of “Data input” in the picture of FIG. 4 means selection of generation of new data. For each manipulation selected in the browser picture, a URL for starting a corresponding CGI program 22 is sent to the Web server 21. The CGI program 22 sends the spreadsheet assisting program 41 action data 200 (see FIG. 2) indicating that the request from the client means 10 is displaying a data input picture. In this case, the action data 200 contains only an action name 201.

Upon reception of the action data 200 indicating display of a data input picture, the spreadsheet assisting program 41 causes the spreadsheet program 31 to generate, as an HTML file, a table frame to be displayed in a data input picture shown in FIG. 5. This HTML file contains only a table frame. Further, the spreadsheet assisting program 41 causes the DBMS 61 to automatically generate a new primary key value corresponding to the HTML table frame and insert the new primary key value into the HTML file. A tag that will not be displayed on the screen when the browser 11 displays the HTML file is attached to the primary key value that has been inserted into the HTML file. The HTML file in which the primary key value 213 is inserted is sent from the CGI program 22 to the Web server 21 and then sent from the Web server 21 to the browser 11. The spreadsheet assisting program 41 holds the primary key value that has been inserted into the HTML file.

When the browser 11 receives the HTML file from the Web server 21 after the selection of “Data input” in the picture of FIG. 4, a data input picture shown in FIG. 5 appears on display of the browser 11. The primary key value is not shown in this picture. When the arrow of an item “Section,” “Purpose of purchase,” or “Article name” is selected, list data of the selected item is sent from the Web server 21. If a “Transmit” button is selected in the picture of FIG. 5 after input of data to each item, the input data and the primary key value that is inserted in the HTML file displayed in the picture of FIG. 5 are sent to the Web server 21 together with a URL corresponding to a data input transmission request.

A CGI program 22 corresponding to the URL that is sent from the browser 11 to the Web server 21 is started, and the input data that were input in the picture of FIG. 5 and the primary key value are passed to the CGI program 22 as parameters. The started CGI program 22 sends the spreadsheet assisting program 41 action data 200 consisting of an action name 201 of data generation, data 202, and a primary key value 203.

As described above, the spreadsheet assisting program 41 holds the primary key value that was inserted by itself into the HTML file that was sent from the Web server means 20 to the client means 10. The spreadsheet assisting program 41 judges whether the primary key value being held by itself coincides with the primary key value received from the client means 10. If they coincide with each other, the spreadsheet assisting program 41 instructs the DBMS 61 to generate a new record, whereby a new record is generated in the DB 62. If the primary key values do not coincide with each other, the spreadsheet assisting program 41 does not instruct the DBMS 61 to generate a new record. For example, the primary key values do not coincide with each other when the primary key value was changed in the client means 10.

Even if the “Transmit” button is selected repeatedly in the picture of FIG. 5, the data merely overwrite the record in the DB 62 having the same primary key value.

(3) If “data modification or deletion” is selected in the menu picture of FIG. 4, a URL for selecting a corresponding CGI program 22 is sent from the browser 11 to the Web server 21 and the corresponding CGI program 22 is started. Action data 200 containing only an action name 201 indicating an action of displaying a data modification or deletion picture is sent from the CGI program 22 to the spreadsheet assisting program 41.

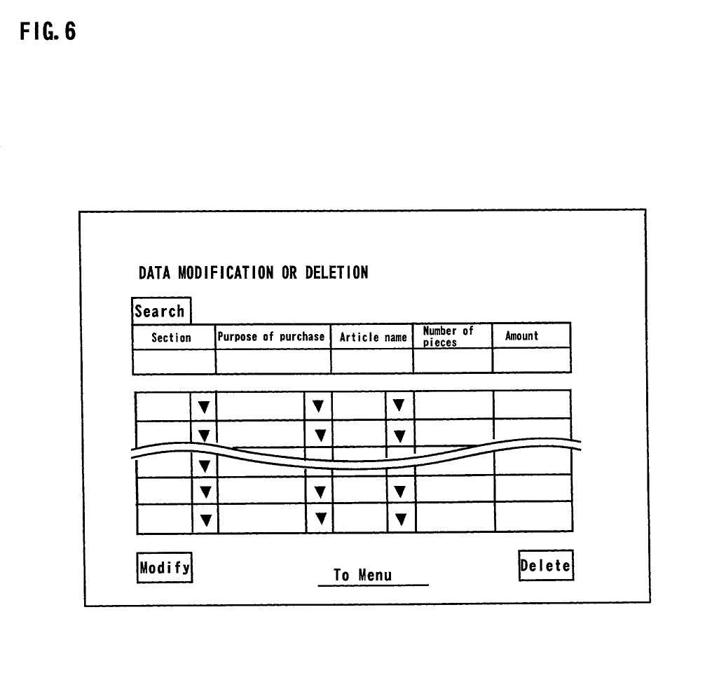

The spreadsheet assisting program 41 causes the spreadsheet program 31 to generate, as an HTML file, a table frame to be displayed in a data modification or deletion picture shown in FIG. 6. This HTML file contains only a table frame. The spreadsheet assisting program 41 acquires, from the link table 42, a primary key value of a table in the DB 62 corresponding to the table frame shown in FIG. 6, and inserts the acquired primary key value into the generated HTML file. The spreadsheet assisting program 41 holds the primary key value that has been inserted into the HTML file. The HTML file in which the primary key value 213 is inserted is sent from the CGI program 22 to the Web server 21 and then sent from the Web server 21 to the browser 11. Then the data modification or deletion picture of FIG. 6 appears on display of the browser 11.

If the user of the browser 11 requests search of data to be modified or deleted, the spreadsheet assisting program 41 acquires a record that matches search data from the database means 60. The spreadsheet assisting program 41 correlates the data of the acquired record with cells and causes the spreadsheet program 31 to generate a table frame and cell data as an HTML file. The spreadsheet assisting program 41 inserts, into the generated HTML file, a primary key value of a table in the DB 62 corresponding to the table frame. The spreadsheet assisting program 41 holds the primary key value that has been inserted into the HTML file. The HTML file thus generated is sent from the Web server 21 to the browser 11 and displayed on the screen. If the user of the browser 11 wants to modify data, he modifies the data in the picture of FIG. 6 in which the search result is displayed and selects a “Modify” button. If the user wants to delete the data, he selects the “Delete” button.

If the “Modify” button is selected, a URL corresponding to modification, the modified data, and the primary key value are sent from the browser 11 to the Web server 21. Action data 200 that is sent from a CGI program 22 corresponding to the URL to the spreadsheet assisting program 41 consists of an action name 201 indicating data modification, the modified data 202, and the primary key value 203 that was inserted in the HTML file that was received by the browser 11. The DBMS 61 causes the data to overwrite the record in the DB 62 indicated by the primary key value. Even if the “Modify” button is selected repeatedly in the picture of FIG. 6, the data merely overwrites the same record in the DB 62.

If the “Delete” button is selected, a URL corresponding to deletion and the primary key value are sent from the browser 11 to the Web server 21. Action data 200 that is sent from a CGI program 22 corresponding to the URL to the spreadsheet assisting program 41 consists of an action name 201 indicating data deletion and the primary key value 203 that was inserted in the HTML file that was received by the browser 11. The DBMS 61 deletes the record in the DB 62 indicated by the primary key value. Even if the “Delete” button is selected repeatedly in the same picture of FIG. 6, the DBMS 61 does not process the deletion request because the corresponding record has already been deleted.

Also when the Web server means 20 receives a data modification or deletion request from the client means 10, the spreadsheet assisting program 41 judges whether a primary key value being held by itself coincides with a primary key value received from the client means 10 as it does when receiving a request for generation of new data. If they coincide with each other, the spreadsheet assisting program 41 instructs the DBMS 61 to modify or delete a record corresponding to the primary key value in the DB 62. If the primary key values do not coincide with each other, the spreadsheet assisting program 41 does not instruct the DBMS 61 to modify or delete a record.

(4) If “Business form output” is selected in the menu picture of FIG. 4, the spreadsheet assisting program 41 acquires, from the DB 62, cell data to be displayed in a business form and causes the spreadsheet program 31 to generate, as an HTML file, a table frame of the business form and cell data. In the case of the business form output, it is not necessary to insert a primary key value into the HTML file.

Upon reception of the HTML file of the business form from the Web server 21, the browser 11 outputs the business form from a printer.

In the first embodiment, the client 10 receives an HTML file in which a primary key value is inserted. When a client performs a manipulation on a picture in which the received HTML file is displayed, a generation, modification, or deletion request having a primary key value received by the client means 10 is sent to the Web server means 20. The spreadsheet assisting program 41 judges whether the primary key value sent from the client means 10 to the Web server means 20 coincides with a primary key value being held by the spreadsheet assisting program 41. With this operation, even if the client means 10 illegally changes the primary key value inserted in the HTML file and sends an illegal generation, modification, or deletion request to the Web server 20, the spreadsheet assisting program 41 does not accept the illegal request.

To correlate the primary key value being held by itself with the client who sent the request, the spreadsheet assisting program 41 holds, together with the primary key value, an authentication number or the like to be used by a client in logging in to access the Web server 21.

Alternatively, an operation is possible in which not only is a primary key value is inserted into an HTML file, but also the same primary value is attached to a cookie and the HTML file and the cookie are sent to the client means 10. When the client means 10 sends a generation, modification, or deletion request to the Web server 20, the spreadsheet assisting program 41 judges whether a primary key value of request data sent from the client means 10 coincides with the primary key value attached to the cookie that is sent from the client means 10 to the Web server means 20 together with the request data. This makes it possible for the spreadsheet assisting program 41 not to accept an illegal generation, modification, or deletion request even if the client means 10 illegally changes the primary key value inserted in the HTML file and sends the illegal request to the Web server 20. Since the primary key value attached to the cookie is used for the coincidence judgment, the spreadsheet assisting program 41 need not hold the primary key value inserted in the HTML file.

In the first embodiment, since a primary key value corresponding to an HTML table frame is inserted into or attached to an HTML file to be sent from the Web server means 20 to the client means 10, the table frame can be linked with the DB 62 having data to be displayed in the table frame of the spreadsheet program 31. Therefore, the client means 10 can generate, modify, or delete data to be displayed in the table frame of the spreadsheet program 31 even over the Internet according to HTTP. Further, even if the Web server means 20 receives an illegal generation, modification, or deletion request from the client means 10, the illegal request can be prevented from being processed.

In the first embodiment, since the browser 11 of the client means 10 displays a table frame and cell data that were generated as an HTML file, it is not necessary to install the client computer a spreadsheet program.

### Embodiment 2

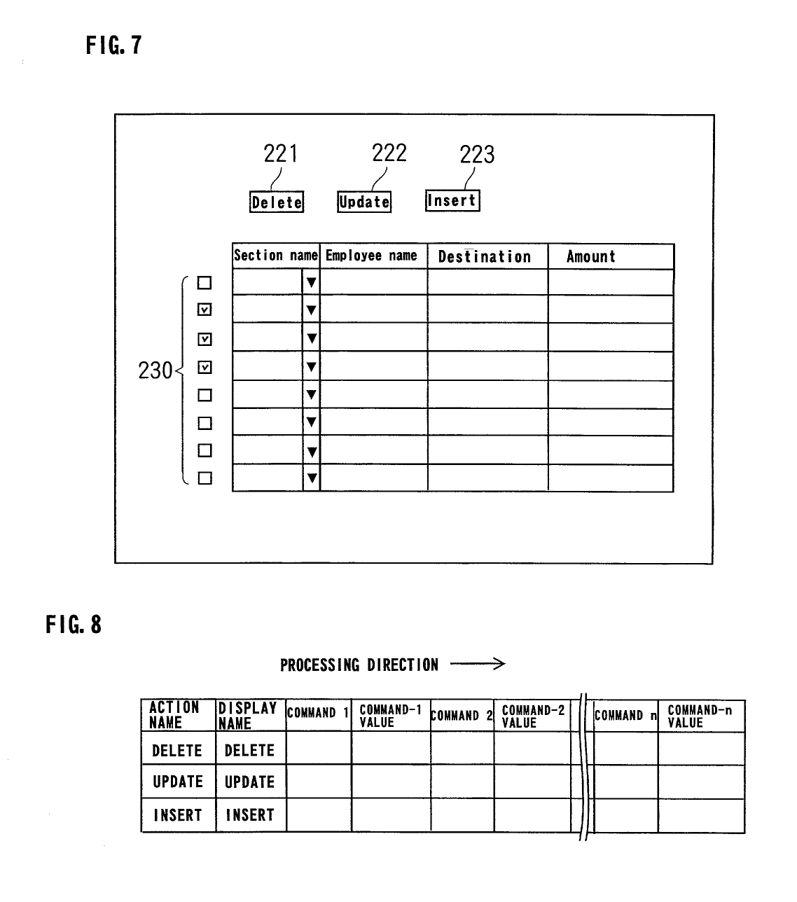

FIG. 7 shows a browser picture of a spreadsheet Web system according to a second embodiment of the invention. The spreadsheet Web system according to the second embodiment is a system that intensively manages traveling expenses on business of a company on the Web. The configuration of the spreadsheet Web system and the data transfer method in the spreadsheet Web system are substantially the same as in the first embodiment.

When a “Delete” button 221, an “Update” (or “Modify”) button 222, or an “Insert” button 223 is selected in a browser picture of a traveling expenses management table shown in FIG. 7 after a connection is made to a traveling expenses management site of the Web server means 20, a request from the client means 10 corresponding to the selected button is sent, as an action, from a CGI program 22 to spreadsheet assisting program 41. Check boxes 230 correspond to the respective rows of the table to be deleted, updated, or inserted.

As shown in FIG. 8, a sequence of commands for processing each action to be sent from a CGI program 22 is defined in the spreadsheet assisting program 41. A command sequence definition table as shown in FIG. 8 is generated for each table frame to be displayed by the browser 11. For example, if the “Delete” button 221 is selected in the browser picture of FIG. 7, the spreadsheet assisting program 41 sequentially executes the commands that are defined in the row of “delete” which is an action name corresponding to deletion. The “Update” button 222 corresponds to an action name “update,” and the “Insert” button 223 corresponds to an action name “insert.”

Each command of a command sequence is formed by command k (k=1, . . . , n; n is set arbitrarily for each action) that defines the contents of processing and a command-k value as a parameter that is used by command k during execution of the action. Examples of command k are an error judgment command that causes display of an error processing picture on a browser picture depending on the command-k value or stops the execution of command k depending on the command-k value, as a result of which the spreadsheet assisting program 41 continues the sequential execution of the commands, a database manipulation command that instructs the DBMS 61 to delete, update, or insert a record of a table frame indicated by the command-k value, and a command that causes the browser 11 to display a table frame indicated by the command-k value or an HTML file indicated by an HTTP address.

For example, consider a case that an error judgment command is defined as command 1 in the command sequence in the “delete” row of FIG. 8 and a value of a formula for calculating the number of checked ones among the check boxes 230 in FIG. 7 is defined as a command-1 value. If (command-1 value)=0, that is, if the number of checked ones among the check boxes 230 is equal to 0, an error processing picture is displayed on the browser 11. If (command-1 value)≧1, that is, if at least one of the check boxes 230 is checked, the execution of command 1 as the error judgment command is stopped and the spreadsheet assisting program 41 executes the next command 2.

Usually, the last command n of each command sequence is a command that causes the browser 11 to display an HTML file having the HTML address indicated by a command-n value , or causes the spreadsheet program 31 to generated, as an HTML file, a table frame indicated by the command-n value and cell data (if there exist cell data to be displayed). An HTML file generated by the spreadsheet program 31 is sent from Web server 21 to the browser 11 and displayed in a browser picture.

Since each command sequence is formed by a small number of commands k and the commands k are executed sequentially, the spreadsheet assisting program 41 can easily generate a process corresponding to an action that is sent from a CGI program 22 in response to a request from the client means 10. Therefore, the spreadsheet assisting program 41 can be developed and maintained easily.

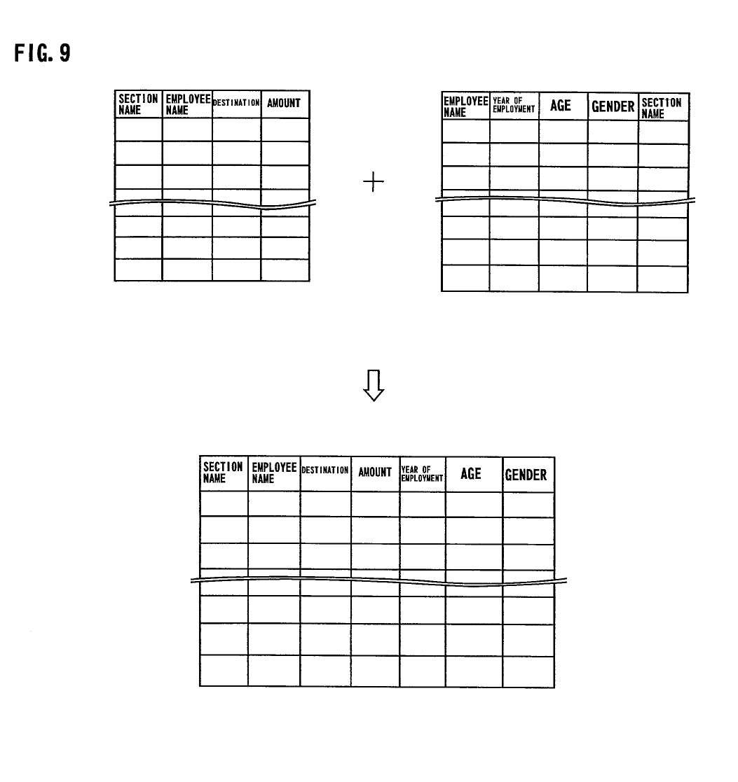

As shown in FIG. 9, the database means 60 according to the second embodiment can combine two tables having the same column items (“Section name” and “Employee name” in FIG. 9) at different column positions into a single table. Therefore, in response to a request from the client means 10, a plurality of table frames having the same column items at different column positions and cell data to be displayed in those table frames can be displayed as and in a single table frame. Since the same column item can be located at a different position, a table frame and a database can be generated easily and can be designed with a high degree of freedom.

### Embodiment 3

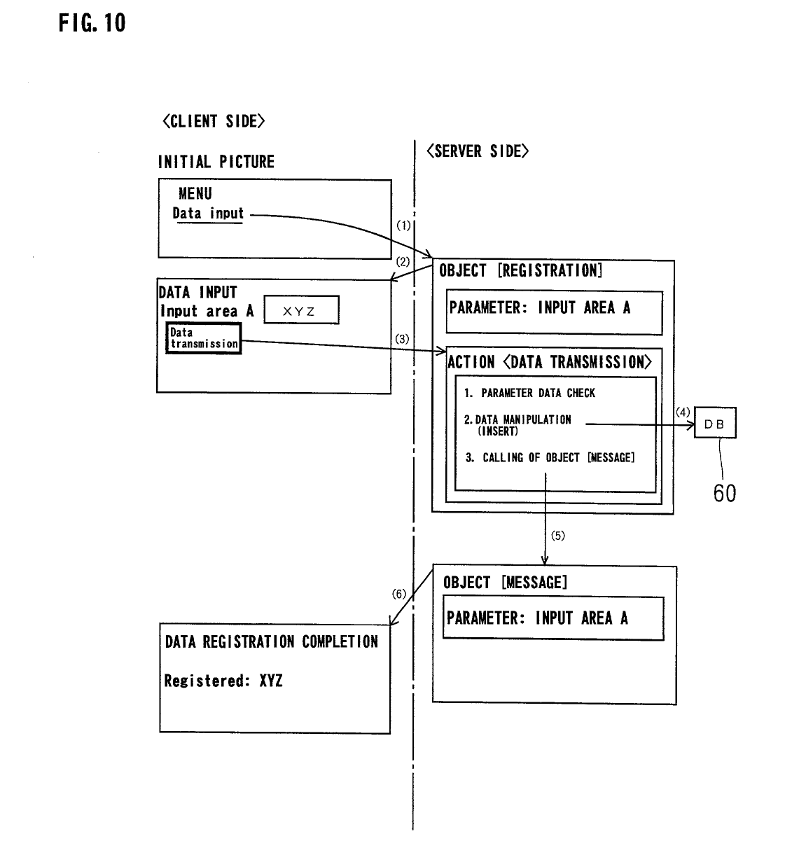

FIG. 10 shows a flow of a process that is executed for a request from the client means 10 in a spreadsheet Web system according to a third embodiment of the invention. The process includes transitions between objects. In the third embodiment, the configuration of the spreadsheet Web system and the data transfer method in the spreadsheet Web system are substantially the same as in the first embodiment. In the third embodiment, the action name of each action data (see FIG. 2) that is sent from a CGI program 22 to the spreadsheet assisting program 41 is the name of an object or the name of an action in an object shown in FIG. 10. Therefore, an object or an action in an object designated by the action name of action data is executed.

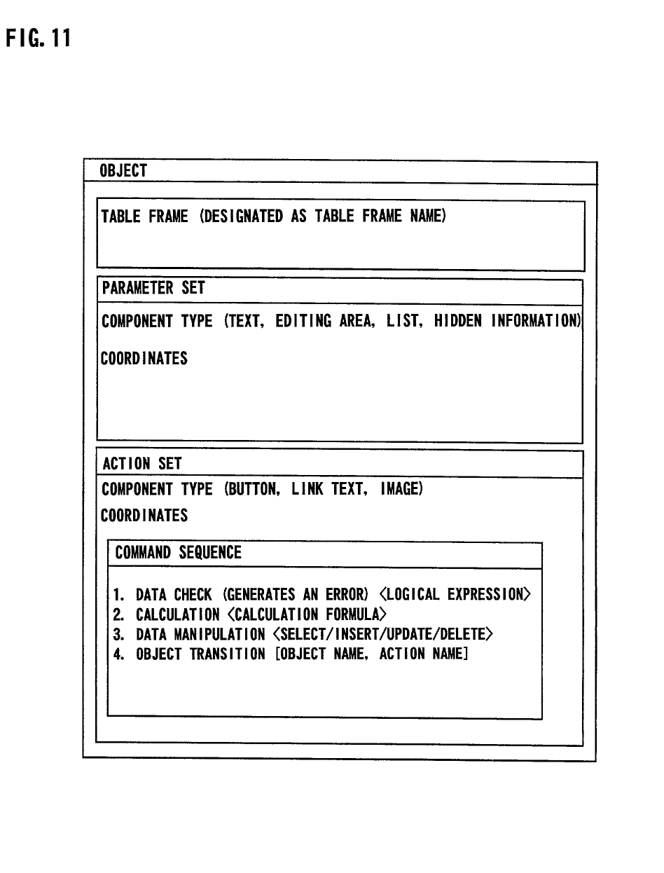

The spreadsheet assisting program 41 of the spreadsheet Web server system has objects [registration] and [message] as objects for processing a request from the client means 10. FIG. 11 shows the basic structure of an object.

One object is formed for each table frame to be displayed in the client means 10. Each object has the name of a table frame to be generated by the spreadsheet program 31 as an HTML file, a parameter set, and an action set.

The parameter set has, for each parameter that is input in the client means 10, a component type (text, editing area, list, hidden information, or the like) of the parameter and coordinates of the parameter to be displayed. The hidden information means information that is not displayed on the screen of the client means 10. The action set has a component type (button, link text, image, or the like) of a button that is displayed in the client means 10, coordinates of the button, and at least one action having a command sequence for processing a request from the client means 10 corresponding to the button. The command sequence has the same structure as that described in the second embodiment. However, in the third embodiment, a table frame to be displayed in the client means 10 is not designated by a command of a command sequence but designated in common by the object to which the action set belongs.

An object is called by using an object name and an action in an object is called by using a combination of an object name and an action name by the client means 10 or an action, respectively, and then executed. A request from the client means 10 is processed by one or a plurality of objects. Where a request from the client means 10 is processed by a plurality of objects, a transition is made from one object to another during the course of execution of the process. A system such as the spreadsheet Web server system according to the third embodiment in which a table frame name, a parameter set, and an action set are specified in an object and the object for processing a request from the client means 10 is changed (processing transition) in such a manner that an object or an action is called by the client means 10 or an action is called an object transition specification type input/output system.

Next, a flow of a process for processing a request from the client means 10 will be described with reference to FIG. 10.

(1) If “Data input” is selected in a menu picture (initial picture) in the client means 10, an object [registration] in the spreadsheet assisting program 41 is called. Since an object, rather than an action, is called, an action <data transmission> in the object [registration] is not executed.

(2) As described above, in the object [registration], a table frame to be generated by the spreadsheet program 31 is designated as a table frame name. When called, the object [registration] causes the spreadsheet program 31 to generate, as an HTML file, a table frame corresponding to the table frame name, whereupon the processing of the object [registration] is finished. The generated table frame is sent from the Web server means 20 to the client means 10.

(3) In the client means 10, data (“XYZ” in FIG. 10) is input to an input area of a data input picture and a “Data transmission” button is selected. Upon the selection of the “Data transmission” button, the action <data transmission> in the object [registration] is called. The data “XYZ” that was input to the input area is entered in a parameter input area of a common parameter table generated by the spreadsheet assisting program 41.

The action <data transmission> checks whether the data “XYZ” in the parameter input area that was input to the input area of the data input picture in the client means 10 is data that is allowed to be input to the input area. For example, the action <data transmission> checks whether a numerical value was input to the input area though characters should be input there. If the data “XYZ” is improper data, an object for displaying an error message in the client means 10 (not shown in the command sequence of the action <data transmission>) is called.

If the input area is an area to which to input a numerical value, if necessary calculation is performed according to a certain calculation formula by using the input numerical value.

(4) If the data “XYZ” in the parameter input area is data that is allowed to be input to the input area, a command “insert” for causing the database means 60 to generate a new record having “XYZ” as data is executed.

(5) Then, the action <data transmission> calls an object [message], whereby a transition is made from the object [registration] having the action <data transmission> to the object [message]. When another object or action is called by one action, a transition is made to another object. Therefore, the object having the action that has called another object or action does not perform processing of causing the spreadsheet program 31 to generate a table frame as an HTML file.

(6) The object [message] causes the spreadsheet program 31 to generate, as an HTML file, a table frame of data registration completion and cell data that is the value “XYZ” in the parameter input area. The generated table frame is sent from the Web server means 20 to the client means 10.

In the third embodiment, as in the case of the second embodiment, since the command sequence of an action is formed by a small number of commands and the commands are executed sequentially, the spreadsheet assisting program 41 can easily generate a process corresponding to an action that is sent from a CGI program 22 in response to a request from the client means 10. Therefore, the spreadsheet assisting program 41 can be developed and maintained easily.

### Embodiment 4

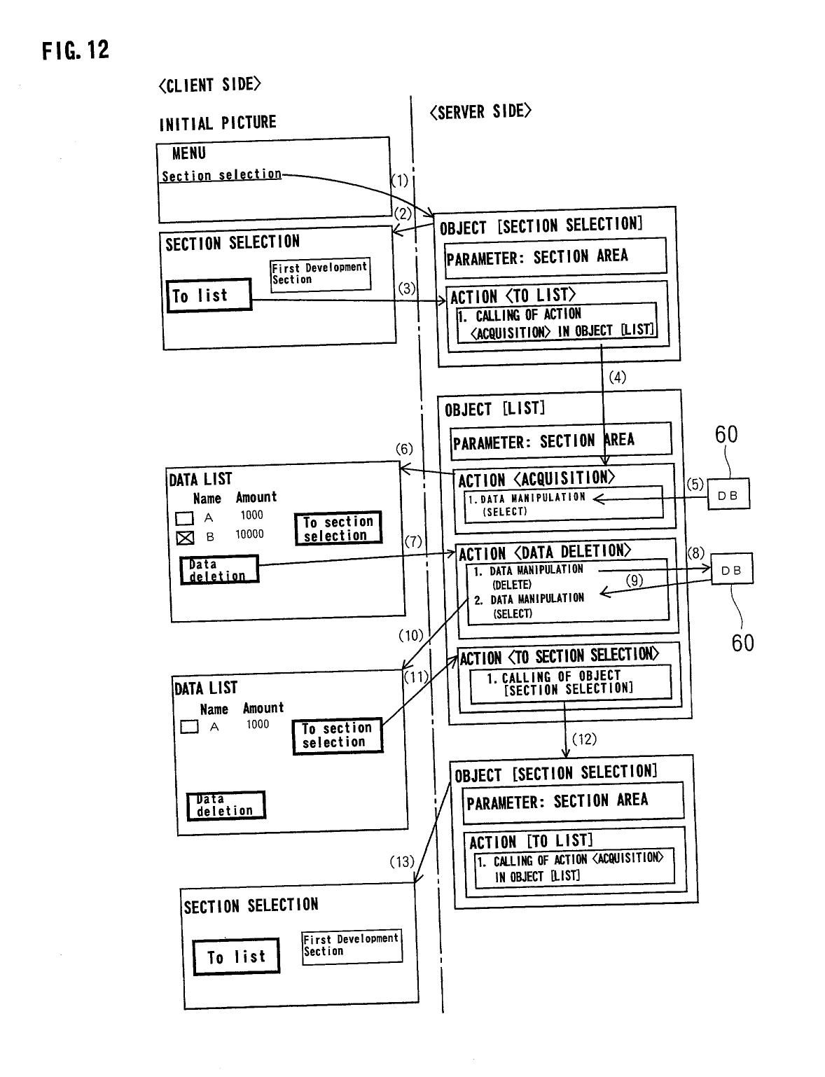

FIG. 12 shows a flow of a process that is executed for a request from the client who wants to perform data editing in a spreadsheet Web system according to a fourth embodiment of the invention. In the fourth embodiment, the configuration of the spreadsheet Web system. the data transfer method in the spreadsheet Web system, and the structures of the object and the action of the spreadsheet assisting program 41 are substantially the same as in the third embodiment.

A flow of a process for processing a data editing request from the client means 10 will be described with reference to FIG. 12.

(1) If “Section selection” is selected in a menu picture (initial picture) in the client means 10, an object [section selection] in the spreadsheet assisting program 41 is called. Since an object, rather than an action, is called, an action <to list> in the object [section selection] is not executed.

(2) In the object [section selection], a table frame to be generated by the spreadsheet program 31 as an HTML file is designated as a table frame name. When called, the object [section selection] causes the spreadsheet program 31 to generate a table frame of section selection as an HTML file, whereupon the processing is finished. The table frame of section selection generated as an HTML file is sent from the Web server means 20 to the client means 10.

(3) In the client means 10, a section name “First Development Section” is input to an input area of a section selection picture and a “To list” button is selected, whereby the action <to list> in the object [section selection] is called. The section name “First Development Section” that was input in the client means 10 is entered in a parameter “section area” in a common parameter table generated by the spreadsheet assisting program 41. A command for judging properness of the section name “First Development Section” that was input in the client means 10 (not shown in the action <to list>) is executed.

(4) If the section name “First Development Section” is proper data, the action <to list>in the object [section selection] calls an action <acquisition> in an object [list]. Since a transition is made from the object [section selection] to the object [list], the object [section selection] does not cause the spreadsheet program 31 to generate a table frame of section selection as an HTML file.

(5) The action <acquisition> that has been called by the action <to list> executes a command “select” for reading out list data of “First Development Section” from the database means 60 and finishes the processing.

(6) Upon the completion of the execution of the action <acquisition>, the object [list] causes the spreadsheet program 31 to generate, as an HTML file, a table frame of a data list and list data of “First Development Section” that have been read from the database means 60 by the action <acquisition> and finishes the processing. The generated HTML file is sent from the Web server 20 to the client means 10.

(7) In the client means 10, the check box of name B in a data list picture is checked and a “Data deletion” button is selected. Upon the selection of the “Data deletion” button, an action <data deletion> in the object [list] is called.

(8) The action <data deletion> executes a “delete” command for causing the database means 60 to delete the record of name B.

(9) Then, a “select” command for reading, from the database means 60, list data of “First Development Section” from which the record of name B has been deleted and finishes the processing.

(10) Upon the completion of the execution of the action <data deletion>, the object [list] causes the spreadsheet program 31 to generate, as an HTML file, a table frame of a data list and list data of “First Development Section” that have been read from the database means 60 by the action <data deletion> and finishes the processing. The generated HTML file is sent from the Web server 20 to the client means 10.

(11) If in the client means 10 a “Section selection” button is selected in the data list picture, an action <to section selection> in the object [list] is called.

(12) The thus-called action <to section selection> calls the object [section selection], whereupon a transition is made from the object [list] to the object [section selection]. Therefore, the object [list] does not cause the spreadsheet program 31 to generate a table frame as an HTML file.

(13) The thus-called object [section selection] causes the spreadsheet program 31 to generate, as an HTML file, a table frame of section selection and finishes the processing. The table frame of section selection that has been generated as an HTML file is sent from the Web server means 20 to the client means 10.

### Embodiment 5

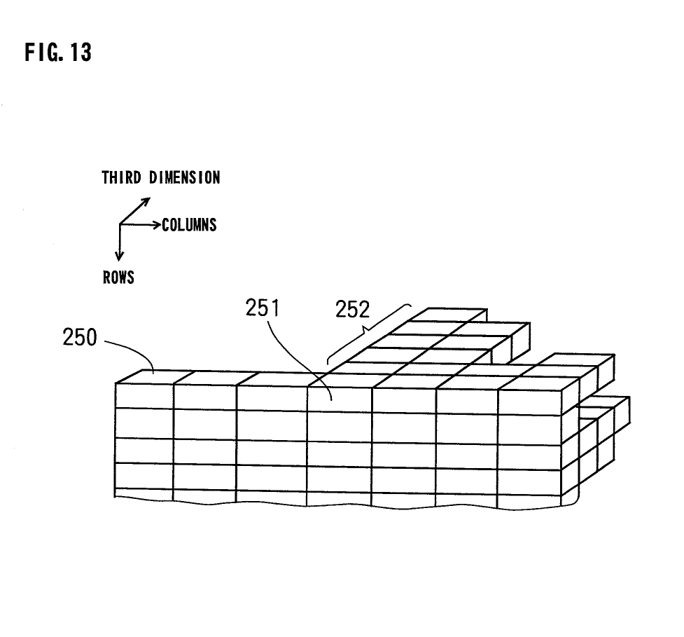

FIG. 13 shows the structure of a cell data group of a spreadsheet Web system according to a fifth embodiment of the invention. In the fifth embodiment, the configuration of the spreadsheet Web system and the data transfer method in the spreadsheet Web system are substantially the same as in the first embodiment.

The database means 60 according to the fifth embodiment has, for at least one cell of a table frame in which to display two-dimensional data 250, parent data 251 that is cell data to be displayed in the cell and at least one child data 252 that is linked to the parent data 251. For example, “Europe” is set as parent data 251 in a business trip destination area and the name of a country in Europe is set as child data 252.

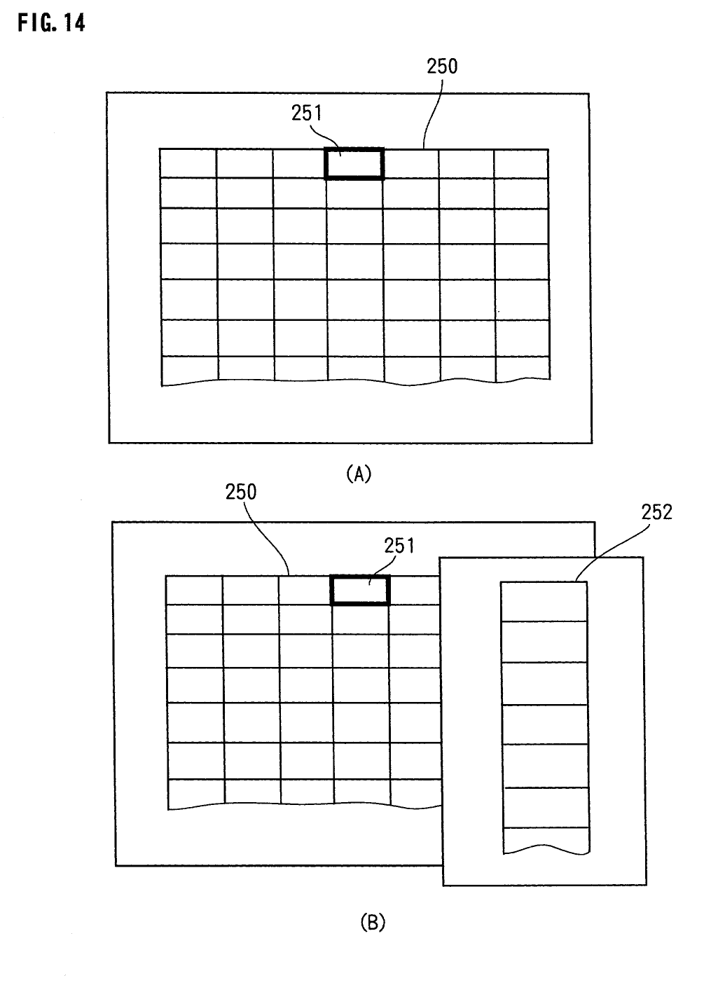

If a cell corresponding to parent data 251 of two-dimensional data 250 being displayed in a browser picture of FIG. 14A is selected and then a “Child data display” button (not shown), for example, is selected, child data 252 of the parent data 251 are displayed in a new browser picture as shown in FIG. 14B. It is also possible to make an instruction to generate, modify, or delete child data in the browser picture in which the child data 252 are displayed.

The child data 252 may be displayed in the same browser picture where two-dimensional data 250 having the parent data 251 are displayed. The child data 252 may be an array, and each child data may be a table. A tree structure may be formed in which each child data also serves as parent data and has child data.

### Embodiment 6

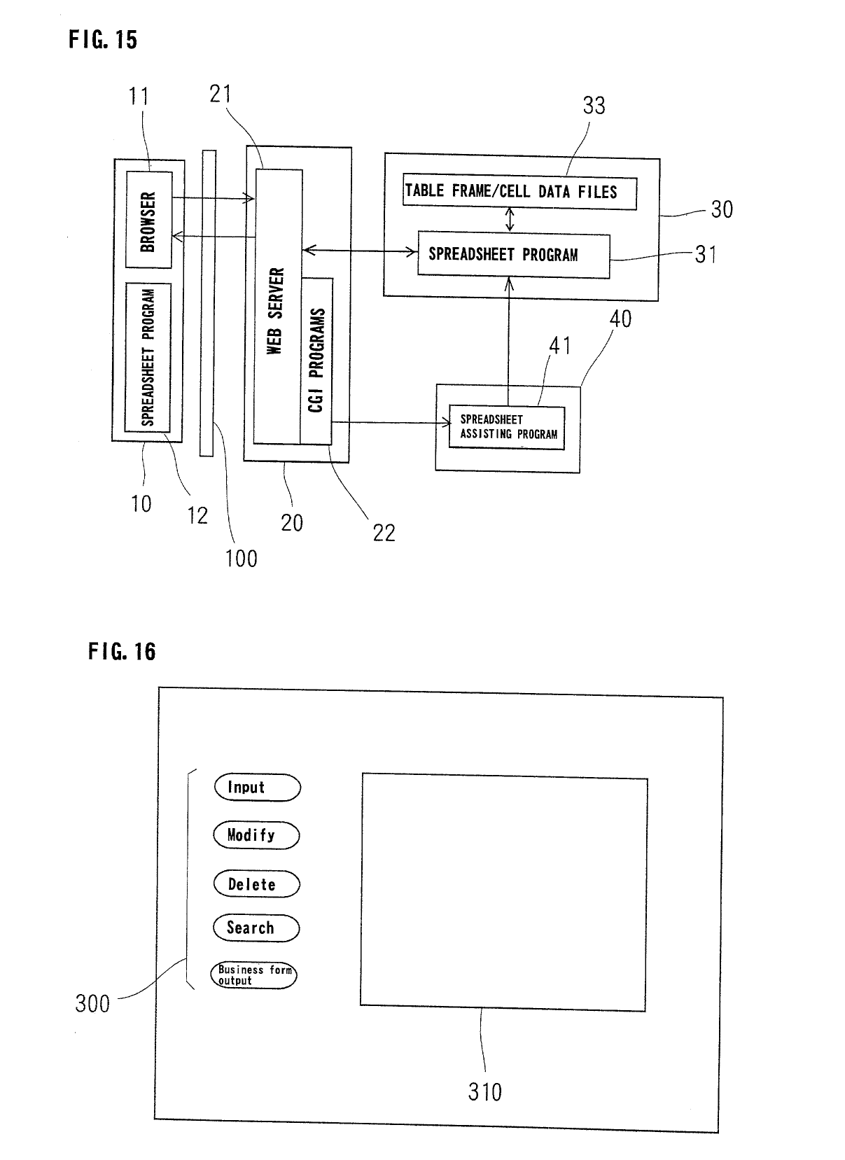

FIG. 15 is a block diagram of a spreadsheet Web system according to a sixth embodiment of the invention.

In the sixth embodiment, a table frame and cell data that are sent to the browser 11 are not an HTML file but a file of a spreadsheet program form. Therefore, it is necessary that a spreadsheet program is installed in the client means 10. Further, since spreadsheet means 30 has a hard disk drive as a table recording means in which table frame/cell data files 33 as spreadsheet files of the spreadsheet program form are recorded, the system according to the sixth embodiment does not have a database means for recording cell data.

As in the case of the first embodiment, when a connection is made to an expenditures management site of the Web server means 20 after starting of the browser 11 in the client means 10, a menu picture shown in FIG. 16 is displayed. A browser tool bar is not shown in the browser picture of FIG. 16.

The menu picture shown in FIG. 16 has a menu display area 300 and a table area 310 where a table frame and cell data of the spreadsheet program 31 are to be displayed. If an “Input,” “Modify,” “Delete,” “Search,” or “Business form output” button is selected in the picture of FIG. 16, a corresponding CGI program 22 is selected and action data is sent to the spreadsheet assisting program 41 as in the case of the first embodiment.

In response to the request from the browser 11, the spreadsheet assisting program 41 causes the spreadsheet program 31 to generate a table frame and cell data as a file of the spreadsheet program form. The spreadsheet program 31 causes the generated file of the spreadsheet program form to be stored in a transmission folder of the Web server 21 for accommodating a file to be sent to the browser 11.

For example, the menu list to be displayed in the menu display area 300 by the browser 11 is stored in the transmission folder of the Web server 21 in the form of an HTML file. The menu list is sent to the browser 11 together with the corresponding file of the spreadsheet program form.

In the sixth embodiment, the spreadsheet assisting program 41 causes the spreadsheet program 31 to generate a file of the spreadsheet program form. Therefore, the browser 11 can generate, modify, and delete a table form or cell data of Web-server-21-side spreadsheet program 31 over the Internet 100 according to HTTP as if to manipulate a spreadsheet program in a stand-alone state.

Although in the sixth embodiment the spreadsheet means 30 itself has the table frame/cell data files 33, the table frame/cell data files 33 may be held as a database.

In the sixth embodiment, the spreadsheet assisting program 41 may serve as a means for processing an action corresponding to a request from the client means 10 and have a command sequence corresponding to each action, as in the case of the second, third, and fourth embodiments.

According to the above-described embodiments of the invention, by virtue of the feature that the spreadsheet assisting program for instructing the spreadsheet program on processing is provided in the spreadsheet assisting means, a table frame or cell data, which can merely be displayed conventionally on the Web, can be generated, modified, or deleted over the Internet according to HTTP. For system development engineers, the development and maintenance of a system is facilitated, because table frames of a spreadsheet program so far accumulated can be used and a known type of, easy-to-manipulate spreadsheet program can be used.

What is claimed is:

1. A spreadsheet Web server system which sends client means, over the Internet or an intranet, according to HTTP, a table frame and cell data of the table frame that are a hyperlink document and are to be displayed in the client means and which generates, modifies, or deletes a table frame or cell data of a spreadsheet program according to a request from the client means, comprising:
spreadsheet means for generating, modifying, and deleting a table frame, the spreadsheet means comprising table frame recording means for recording table frames in which cells are arranged in at least one of a row direction and a column direction;
database means for recording and managing, as tables, cell data groups to be displayed in cells of a table frame;
Web server means for sending the client means a table frame and cell data of the table frame that are a hyperlink document and are to be displayed in the client means and receiving, from the client means, a request for generation, modification, or deletion of cell data by performing data communication with the client means over the Internet or the intranet according to HTTP; and
spreadsheet assisting means for reading cell data from the database means and causing the spreadsheet means to generate a hyperlink document file of a table frame and the read-out cell data according to a request from the client means, or for causing the database means to generate, modify, or delete a record according to a request from the client means for generation, modification, or deletion of cell data,
wherein the spreadsheet assisting means inserts or attaches a primary key value of a table of the database means corresponding to the table frame generated as the hyperlink document file by the spreadsheet means into or to the hyperlink document file; and
wherein the Web server means sends the client means the hyperlink document file in or to which the primary key value is inserted or attached, and, in receiving a request for generation, modification, or deletion of cell data from the client means, receives, from the client means, the primary key value that was inserted into or attached to the hyperlink document file when the hyperlink document file was sent to the client means.

2. The spreadsheet Web server system according to claim 1, wherein the spreadsheet assisting means comprises link information recording means which records link information that correlates the table frames held by the spreadsheet means with the tables held by the database means.

3. The spreadsheet Web server system according to claim 1 or 2, wherein when receiving a request for generation, modification, or deletion of cell data from the client means the spreadsheet assisting means judges whether the primary key value that was sent to the client means coincides with the primary key value that has been received from the client means, and wherein the spreadsheet assisting means causes the database means to generate, modify, or delete a record designated by the primary key value according to the request from the client means if they coincide with each other, and does not cause the database means to generate, modify, or delete the record if they do not coincide with each other.

4. The spreadsheet Web server system according to any one of claims 1 to 3, wherein the cell data group of each of the tables held by the database means has cell data, as parent data, displayed in at least one cell of a corresponding table frame and has the parent data only, or the parent data and at least one child data that is linked to the parent data.

5. The spreadsheet Web server system according to claim 4, wherein the spreadsheet assisting means causes, according to a request from the client means, the spreadsheet means to generate, as a hyperlink document file, a table frame in which to display a child data group of a cell concerned of a table frame being displayed in the client means and the child data group and the Web server means sends the hyperlink document file generated by the spreadsheet means to the client means, or wherein the spreadsheet assisting means causes the database means to generate, modify, or delete a record according to a request from the client means for generation, modification, or deletion of child data.

6. The spreadsheet Web server system according to any one of claims 1 to 5, wherein the database means can combine a plurality of tables having the same column item at different column positions.

7. The spreadsheet Web server system according to any one of claims 1 to 6, wherein the spreadsheet assisting means has a sequence of commands for processing a request from the client means, the commands being executed sequentially.

8. The spreadsheet Web server system according to any one of claims 1 to 6, wherein the spreadsheet assisting means has objects for processing a request from the client means, and wherein a request from the client means is processed by one object or processed by a plurality of objects in such a manner that a transition is made from one object to another.

9. The spreadsheet Web server system according to claim 8, wherein at least one of the objects has at least one action that is a sequence of commands for processing a request from the client means, the commands being executed sequentially, and wherein an object or an action is called by the client means or another action.

10. The spreadsheet Web server system according to claim 8 or 9, wherein the objects are provided for the respective table frames.

11. A spreadsheet Web server system which sends client means, over the Internet or an intranet, according to HTTP, a spreadsheet file having a table frame and cell data to be displayed in the client means and which generates, modifies, or deletes a table frame or cell data of a spreadsheet program according to a request from the client means, comprising:
spreadsheet means for generating, modifying, and deleting a table frame or cell data, the spreadsheet means comprising table recording means for recording table frames in which cells are arranged in at least one of a row direction and a column direction and cell data to be displayed in the cells of the table frames;
Web server means for sending the client means a spreadsheet file to be displayed in the client means and receiving, from the client means, a request for generation, modification, or deletion of a table frame or cell data by performing data communication with the client means over the Internet or the intranet according to HTTP; and
spreadsheet assisting means for causing the spreadsheet means to generate a spreadsheet file according to a request from the client means, or for causing the spreadsheet means to generate, modify, or delete a table frame or cell data according to a request from the client means.

12. A spreadsheet Web system comprising:
the spreadsheet Web server system according to any one of claims 1 to 10; and
client means that performs data communication with the Web server means over the Internet or the intranet according to HTTP.
